(19) United States
(12) Patent Application Publication
(10) Pub. No.: US 2009/0165728 A1
(43) Pub. Date: Jul. 2, 2009

(54) PILLOW POCKET PET BED

(76) Inventor: Kari Swanson, Sugar Grove, IL (US)

Correspondence Address: BANNER & WITCOFF, LTD., TEN SOUTH WACKER DRIVE, SUITE 3000, CHICAGO, IL, 60606, US

(21) Appl. No.: 11/964,891

(22) Filed: Dec. 27, 2007

(51) Int. Cl. A01K 29/00

(52) U.S. Cl. 119/28.5

(57) ABSTRACT

The disclosure relates to a pet bed which is constructed with two pieces of fabric which are folded over on another. Two stitches may be used for the seams along the width sides and two additional stitches down the vertical and horizontal middle which create four compartments. The compartments are filled with a filling material, such as pillows or blankets. The pet bed described may be flexible, durable, easy to travel with, and easy to clean because of the modular and compartmental design. The filling material may be easily removed in order to travel or clean the pet bed.

### FIELD OF THE INVENTION

This disclosure relates generally to accessories for pets such as dogs and cats. More particularly, it relates to a pet bed and more specifically a dog, although, this same disclosure could be used for a cat or other pet as well.

### BACKGROUND

Pet beds normally are designed with a cover and a large filling piece that may be removed. Designs include a fully integrated cover filled with permanent filling. Normally, the wear and tear of these beds limits their lifespan. One reason is a normal pet bed is difficult to clean because of their inherent design with a cover and a large filling piece. Also, this large filling piece wears down and loses its cushion during the normal wear and tear.

Because the size and bulkiness of these pet beds, these beds are also difficult to travel with. It is difficult to pack these beds when travelling with your pet because the beds do not fold.

Current pet beds are also more prone to flipping over or folding over from the pet's use on the bed. The pet will normally scratch and dig at the bed in order to make a comfortable spot, and this can cause the bed to flip or fold over making the pet bed relatively useless.

### BRIEF SUMMARY

Aspects of the present disclosure address one or more of the issues mentioned above by disclosing a pet bed with pillow pockets. The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

In one embodiment, a pillow pocket pet bed may be constructed using two pieces of rectangular fabric, one main piece and one secondary piece. The secondary piece may be set on the back-side of the main piece. The two width ends of the main piece may be folded over on top of the secondary piece. A seam is stitched along each of the length sides of the main piece attaching the main piece to the secondary piece. Further, two additional stitches are stitched, one down the middle in a horizontal direction and one in the middle in a vertical direction. These middle stitches may create compartments, in which a filling material, such as a pillow or blankets may be used to fill each compartment, thereby creating the pillow pocket pet bed.

This aspect and other aspects of the disclosure are discussed in greater detail throughout this disclosure, including the accompanying drawings.

### BRIEF DESCRIPTION OF THE DRAWINGS

The present disclosure is illustrated by way of example and not limited in the accompanying figures in which like reference numerals indicate similar elements and in which:

FIG. 1 illustrates a top view of the main piece of fabric in accordance with an aspect of the invention;

FIG. 2 illustrates a top view of the secondary piece of fabric in accordance with an aspect of the invention;

FIG. 3 illustrates a bottom view of the main piece of fabric with the secondary piece of fabric set on top in accordance with an aspect of the invention;

FIG. 4 illustrates a top view of an embodiment of the completed pet bed in accordance with an aspect of the invention; and

FIG. 5 illustrates a bottom view of an embodiment of the completed pet bed in accordance with an aspect of the invention.

### DETAILED DESCRIPTION

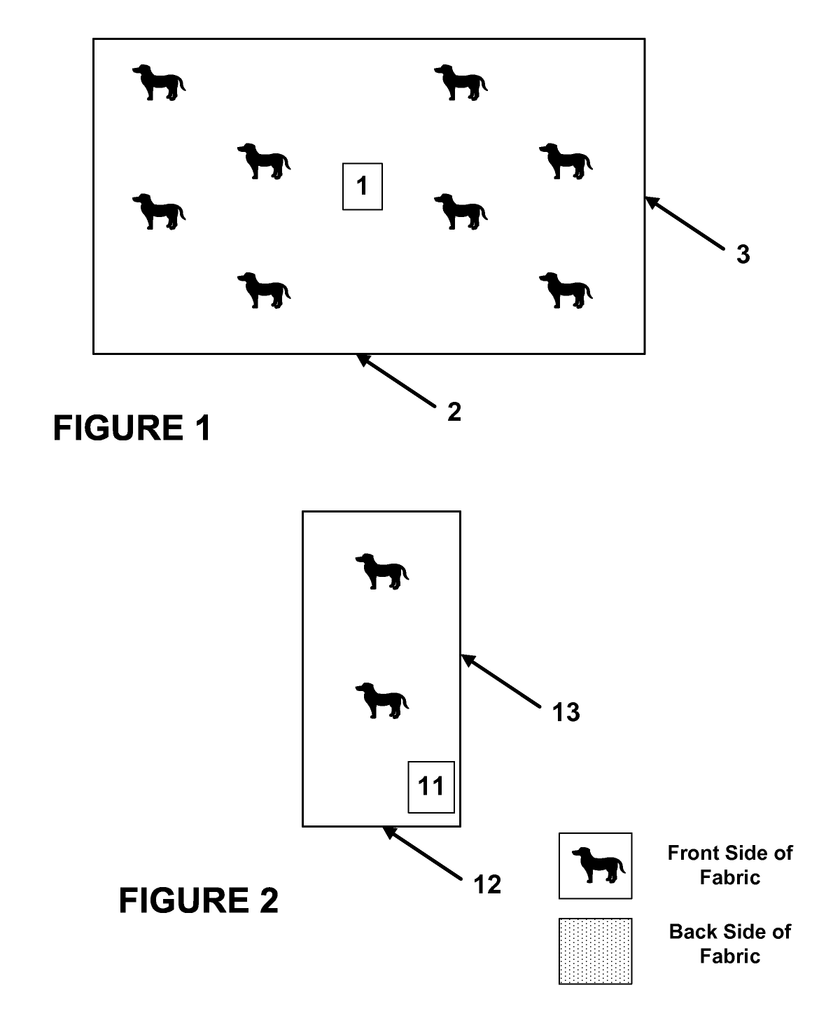

In accordance with an aspect of the invention, FIG. 1 identifies a top view of the main piece of fabric 1 for constructing the pillow pocket pet bed. In an embodiment, the main piece of fabric 1 may be in the shape of a rectangle with an approximate length 2 to width 3 ratio of 7:4. The main piece of fabric 1 may be a durable, yet comfortable fabric for the pet to sleep and lay on. Also, the main piece of fabric 1 may be machine washable, as the main piece of fabric 1, when completed, may be capable of being removed from the pillow pocket pet bed and washed in a washing machine. Some possible recommended fabrics that may be used are berber, denim, broadcloth, or faux fleece. Some fabrics come with graphics that may be suited for a pet bed, such as dogs, bones, or paw prints. One skilled in the art will appreciate that different shapes, dimensions, and materials can be used for the main piece of fabric 1.

FIG. 2 identifies a top view of the secondary piece of fabric 11 for constructing the pillow pocket pet bed in accordance with an aspect of the invention. In an embodiment, the secondary piece of fabric 11 may be in the shape of a rectangle, with an approximate length 12 to width 13 ratio of 1:2. The width 13 of the secondary piece of fabric 11 may be equal to the width 13 of the main piece of fabric 1. The secondary piece of fabric 11 may be a durable, yet comfortable fabric for the pet to sleep and lay on. Also, the secondary piece of fabric 11 may be machine washable, as the secondary piece of fabric 11, when completed, may be capable of being removed from the pillow pocket pet bed and washed in a washing machine. Some possible recommended fabrics that may be used are berber, denim, broadcloth, or faux fleece. Some fabrics come with graphics that may be suited for a pet bed, such as dogs, bones, or paw prints. One skilled in the art will appreciate that different shapes, dimensions, and materials can be used for the secondary piece of fabric 11.

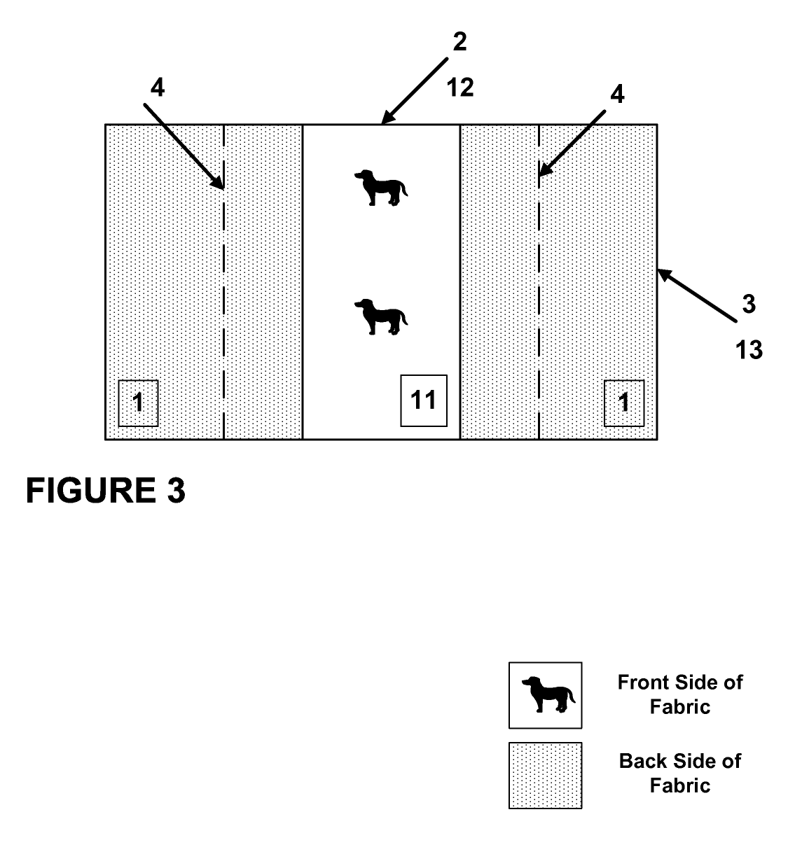

In FIG. 3, to construct the pillow pocket pet bed, the main piece 1 may be set flat with the top side facing down in accordance with an aspect of the invention. The secondary piece 11 may be placed on top of the main piece 1, directly in the middle of the of the main piece 1 with the length 12 of the secondary piece 11 matching up directly with the length 2 of the main piece 1. Once this is completed, the width ends 3 of the main piece 1 may be folded over so that they overlap the secondary piece 11. The main piece 1 may be folded at each of the two main piece fold lines 4. These fold lines 4 may be located approximately ⅕^{th} of the main piece length 2 from each of the main piece width sides 3.

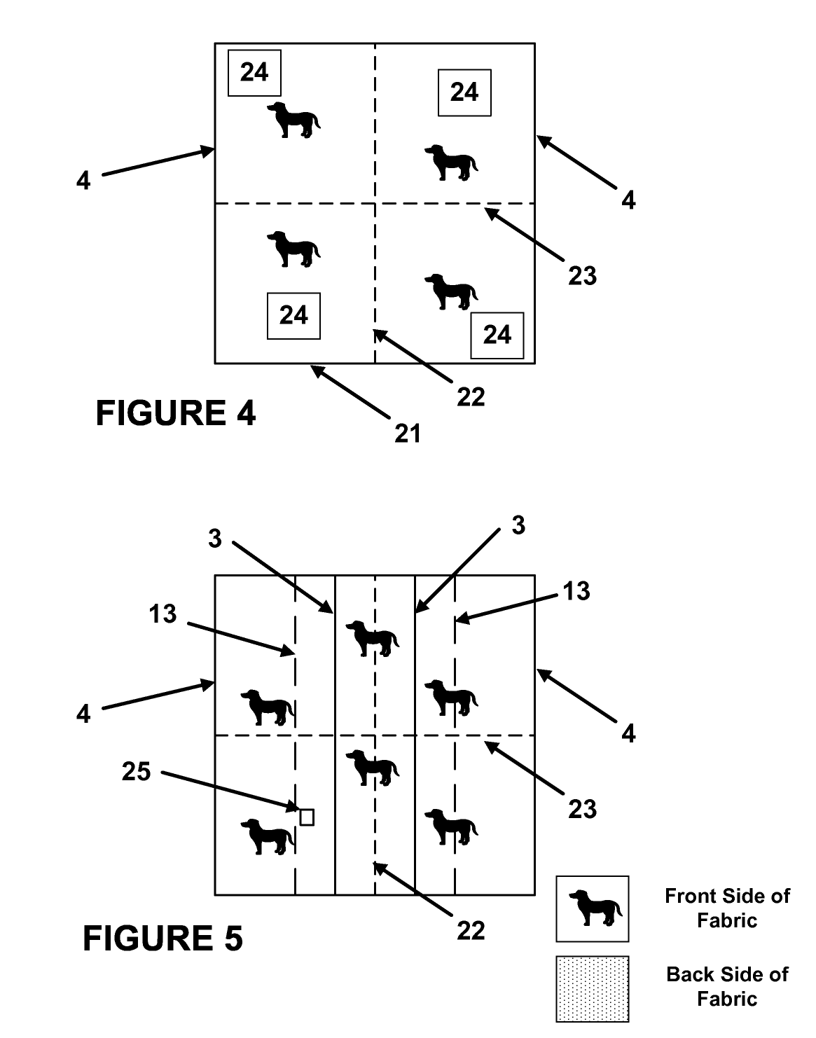

In FIG. 4, in accordance with an aspect of the invention, after both sides of the main piece 1 is folded at the main piece fold lines 4, main piece 1 and secondary fabric 11 may be then attached to each other along each length 2 of the main piece. In an embodiment, the fabric is attached by stitching a seam 21 along each main piece length side 2. One skilled in the art will appreciate that other methods may be used in order to attach this fabric to one another at the seam 21 on the main piece length side 2. Once this is completed, the pet bed may now be in its final shape, a square.

After the seam 21 stitching is completed, two additional stitches may be stitched on the bed. In an embodiment, one vertical stitch 22 is stitched down the middle of the bed. Further, one horizontal stitch 23 may be stitched lengthwise across the middle of the bed. The vertical stitching 22 and horizontal stitching 23 may create the compartments 24 to the pet bed. In an embodiment, the pet bed may have four compartments 24. One skilled in the art will appreciate that additional compartments can be created by varying the stitching patterns.

Once the compartments have been created, the pet bed may be ready to be filled with a filling material. To accomplish this, the original main piece of fabric 1 width side 3 may be pulled slightly back while the original secondary piece of fabric width side 13 is slightly pulled back in the opposite direction, thereby creating an opening to the compartment 24. Once this opening is created, the filling material may be set into the compartment 24. Once the filling material is set into the compartment 24, each of the sides is released, thereby closing the compartment 24 and ensuring that the filling material remains in the compartment. This compartment 24 may be maintained closed because of the main piece width 3 overlapping with the secondary piece width 13. Some possible filling material may include pillows, blankets, or foam. The filling material may be set into any of the compartments or all of the compartments. One skilled in the art will appreciate that other materials may be set into the compartment and used as the filling material.

In another aspect of the invention, the pet bed may include a means for filling at least one of the compartments 24. The means for filling may include pillows, blankets, or foam.

In another aspect of the invention, a fastener 25 may be attached to main piece width side 3 to ensure that it stays closed. This fastener 25 may be located along the edge of the main piece width side 3. Some possible fasteners include be Velcro, zippers, or snaps. One skilled in the art will appreciate that other fasteners may be used to perform this function.

When a user wants to clean the pillow pocket pet bed, the user may remove the filling material and then place the pillow pocket pet bed into the washing machine. If the filling material is dirty and requires cleaning, the filling material may be either cleaned or replaced rather inexpensively.

In an embodiment, when a user wants to travel with the pillow pocket pet bed, the user may remove the filling material and then the pillow pocket pet bed may be folded up to a very small size and placed in a suitcase for travel. Once at a hotel or other destination, the user can utilize pillows or any other filling material already present at the hotel as the filling material for their pet bed. Because of the flexibility of the pillow pocket pet bed, any filling material may be used.

It should also be noted that the pillow pocket pet bed, with the filling material, may be difficult for the pet to flip over or fold over because of the compartmentalized structure and design of the pet bed. When a pet prepares for resting, it will sometimes dig and paw at the bed in order to get comfortable.

Furthermore, it should also be noted that in various aspects of the invention, that the two main seams on the pet bed, along each length side of the main piece of fabric, there may be no durability issues with this pet bed. These seams may provide a strong structure that is resistant to tearing.

Aspects of the invention have been described in terms of illustrative embodiments thereof Numerous other embodiments, modifications, and variations within the scope and spirit of the appended claims will occur to persons of ordinary skill in the art from a review of this disclosure.

We claim:

1. A pet bed comprising:
a plurality of fabric pieces, the plurality of fabric pieces comprising:
a main piece, the main piece attached on each side creating a seam, wherein the seam runs along an entire unfolded portion of the main piece; and
a secondary piece, the secondary piece set on the main piece, the main piece folded over the secondary piece creating a fold on each end of the pet bed, wherein the fold, the seam, and an overlapping main piece and secondary piece form a compartment;
a plurality of compartments, wherein the plurality of fabric pieces are attached together to form the plurality of compartments; and
a filling material set into at least one of the plurality of compartments.

2. The pet bed of claim 1, further comprising two stitches which attach the secondary piece to the main piece, wherein one stitch is a horizontal stitch, while the other stitch is a vertical stitch.

3. The pet bed of claim 2, wherein the horizontal stitch is located in a middle of the pet bed.

4. The pet bed of claim 2, wherein the vertical stitch is located in a middle of the pet bed.

5. The pet bed of claim 1, wherein the filling material comprises pillows.

6. The pet bed of claim 1, wherein the filling material comprises blankets.

7. The pet bed of claim 1, wherein the filling material comprises foam.

8. The pet bed of claim 1, wherein the fabric comprises berber.

9. The pet bed of claim 1, wherein the fabric comprises denim.

10. The pet bed of claim 1, wherein the fabric comprises broadcloth.

11. The pet bed of claim 1, wherein the fabric comprises faux fleece.

12. The pet bed of claim 1, wherein the plurality of compartments comprises at least four compartments.

13. A pet bed comprising:
a plurality of fabric pieces, the plurality of fabric pieces comprising at least a main piece and a secondary piece;
a plurality of compartments, the plurality of fabric pieces attached together to form the plurality of compartments; and
a filling material set into at least one of the plurality of compartments.

14. The pet bed of claim 13, wherein the main piece is attached on each side creating a seam, the seam running along an entire unfolded portion of the main piece.

15. The pet bed of claim 14, wherein the secondary piece is set on the main piece, and the main piece is folded over the secondary piece, creating a fold on each end of the pet bed, wherein the fold, the seam, and an overlapping main piece and secondary piece form a compartment.

16. The pet bed of claim 13, further comprising two stitches which attach the secondary piece to the main piece, wherein one stitch is a horizontal stitch, while the other stitch is a vertical stitch.

17. The pet bed of claim 16, wherein the horizontal stitch is located in a middle of the pet bed.

18. The pet bed of claim 16, wherein the vertical stitch is located in a middle of the pet bed.

19. The pet bed of claim 13, wherein the filling is selected from at least a list of pillows, blankets, and foam.

20. A pet bed comprising:
a plurality of fabric pieces, the plurality of fabric pieces comprising at least a main piece and a secondary piece;
a plurality of compartments, the plurality of fabric pieces attached together to form the plurality of compartments; and
means for filling at least one of the plurality of compartments.
